(19) United States
(12) Patent Application Publication
(10) Pub. No.: US 2014/0191570 A1
(43) Pub. Date: Jul. 10, 2014

(54) SWITCHING DEVICE FOR A MOTOR VEHICLE

(71) Applicant: GM GLOBAL TECHNOLOGY OPERATIONS LLC, Detroit, MI (US)

(72) Inventors: Muhammad Bilal Khan NIAZI, Mainz-Bischofsheim (DE); Winfried BOECKER-SIEGERT, Trebur (DE)

(73) Assignee: GM GLOBAL TECHNOLOGY OPERATIONS LLC, Detroit, MI (US)

(21) Appl. No.: 14/097,090

(22) Filed: Dec. 4, 2013

(30) Foreign Application Priority Data
Dec. 5, 2012 (DE) 10 2012 023 772.3

(51) Int. Cl. B60R 16/03

(52) U.S. Cl. CPC B60R 16/03
USPC 307/10.1

(57) ABSTRACT

A switching device is provided that includes, but is not limited to a switching organ, an actuator for changing a state of a mechanism, a control electronic system for actuating the actuator as a function of the actuating of the switching organ. The actuator is connected mechanically to the mechanism with a push-push mechanism, so that upon a temporary activating of the actuator a first state of the mechanism is changeable from the first state into a second state and following the second state is continuously retrained with the deactivated actuator up to the next temporary activating of the actuator and upon a temporary activating of the actuator a second state of the mechanism is changeable from the second state into a first state and following this the first state is continuously retained with the deactivated actuator up to the next temporary activating of the actuator.

### CROSS-REFERENCE TO RELATED APPLICATION

This application claims priority to German Patent Application No. 10 2012 023 772.3, filed Dec. 5, 2012, which is incorporated herein by reference in its entirety.

### TECHNICAL FIELD

The technical field relates to a switching device, and more particularly to a switching device for a motor vehicle.

### BACKGROUND

Switching devices are used in motor vehicles in order to change a state of a mechanism. To this end, the actuator is indirectly actuated with a switching organ, for example a push button switch, for changing the state of the mechanism. Here, the actuator is activated as a function of the actuating of the switching organ, in that with a control electronic system the actuating of the switching organ is sensed and as a function thereof, the actuator is activated and deactivated by means of the control electronic system.

In particular in three-door motor vehicles, the front seats have a pivot mounting for pivoting a back part about a pivot axis. By means of a locking mechanism as mechanism, the pivotability of the back part about the pivot axis can thereby be locked and unlocked, so that because of this in the unlocked state of the locking mechanism the back part is pivotable about the pivot axis and in a locked state of the locking mechanism the back part is fixedly mounted with respect to the pivot axis, i.e., unpivotably fastened to the seat part of the vehicle seat.

In view of the foregoing, at least one object is to make available a switching device and a motor vehicle in which the mechanism, in particular a locking mechanism, can be simply changed in the state with a switching organ, in particular a push button. In addition, other objects, desirable features and characteristics will become apparent from the subsequent summary and detailed description, and the appended claims, taken in conjunction with the accompanying drawings and this background.

### SUMMARY

A switching device, in particular for a motor vehicle, is provided that comprises a switching organ for actuation by a user, an actuator for changing a state of a mechanism, a control electronic system for activating the actuator as a function of the actuating of the switching organ. The actuator is operationally connected mechanically to the mechanism with a pull-pull mechanism or a push-push mechanism, so that on temporarily activating the actuator, a first state of the mechanism is changeable from the first state into a second state and following this the second state is continuously retained with the deactivated actuator up to the next temporary activating of the actuator and upon a temporary activating of the actuator, a second state of the mechanism is changeable from the second state into a first state and following this the first state is continuously retained with the deactivated actuator up to the next temporary activating of the actuator. A temporary activating of the actuator for a short time, for example during a period of time of approximately 100 ms, causes a change of the state of the mechanism. Thus, the mechanism can be changed from the first state into the second state and vice versa from the second state into the first state.

Here, an activating of the actuator is only required during the changing of the state and outside these times the actuator can remain deactivated and the state of the mechanism simultaneously remains unchanged. Because of this, a lower energy expenditure is required, since an activating of the actuator, for example a brief energizing of the actuator, is required only for changing the state of the mechanism outside these times, no energy for the actuator is required. A pull-pull mechanism or a push-push mechanism in this case constitutes a mode of operation of a ball-point pen mechanism. Through a mechanical actuating of the pull-pull mechanism or the push-push mechanism with the actuator and the mechanical operative connection between and the mechanism, the state of the mechanism can be changed by actuating the actuator by means of the pull-pull mechanism and the push-push mechanism and this state is continuously and permanently retained thereafter, without energy expenditure for the actuator.

In an additional embodiment, a state of the mechanism is changeable upon each temporary actuating of the actuator, in particular the first or second state of the mechanism is changeable from the first or the second state into a second or first state and following this the second or first state constantly remains with the deactivated actuator up to the next temporary activating of the actuator. Upon each temporary activating of the actuator, the state is thus changed, in particular from the first state into the second state, provided that the first state of the mechanism is present or from the second state into the first state, provided the second state of the mechanism is present. Following this, this new state of the mechanism is continuously and permanently retained. In an additional embodiment, the actuator is an electromagnet or an electric motor.

In a complementary version, the actuator is activated for a period of time between approximately 10 s and approximately 1 ms, in particular between approximately 1 s and approximately 10 ms, in particular supplied with current, for changing the state of the mechanism. For example, the actuator is temporarily energized for a period of the time of approximately 1 ms, so that because of this the actuator as electromagnet changes the state of the mechanism with the pull-pull mechanism or push-push mechanism. Because of this, only little energy and only during a change of state is required for the mechanism. In an embodiment, the switching organ is designed as a push button or a rotary switch.

Practically, the control electronic system and/or the switching device are/is designed such that from a predetermined period of time, preferentially between approximately 1 s and approximately 10 ms, in particular between approximately 400 ms and approximately 100 ms, of the actuated switching organ, in particular of the pressed push button, the actuator is temporarily activated and because of this the mechanism changed into the second state. Thus a certain minimum time of actuating the switching organ, in particular a pressing of the push button, is required in order for the actuator to be temporarily activated by the control electronic system and/or the switching device. This is to avoid an unintentional activating of the actuator, for example upon a brief pressing of the push button, inadvertently or during an accident.

In a further embodiment, the control electronic system and/or the switching device are/is designed to the effect that from a predetermined period of time, preferentially between approximately 1 s and approximately 10 ms, in particular between approximately 400 ms and approximately 100 ms, of the unactuated switching organ while the mechanism is in the second state, the actuator, from the predetermined period of time of the unactuated switching organ, in particular of the relaxed push button, is temporarily activated and because of this the mechanism changed into the first state.

In another embodiment, the pull-pull mechanism or the push-push mechanism is operationally connected mechanically to the mechanism with a connecting part, in particular a control cable and/or the pull-pull mechanism or the push-push mechanism is operationally connected mechanically to the actuator, in particular the electromagnet with a pin and an elastic element, in particular a spring, acting on the pin. Practically, the mechanism is a locking mechanism for a pivot mounting of a back part of a vehicle seat and the first state of the locking mechanism is a locked state and the second state of the locking mechanism is an unlocked state.

A motor vehicle according to an embodiment that comprises at least one vehicle seat, in particular front seat, each with a back part and each with a seat part, at least one pivot mounting with at least one locking mechanism for the at least one back part of the at least one vehicle seat, a switching device for locking and unlocking the at least one locking mechanism. The at least one switching device is designed as a switching device described in this patent application.

### BRIEF DESCRIPTION OF THE DRAWINGS

The present invention will hereinafter be described in conjunction with the following drawing figures, wherein like numerals denote like elements, and:

FIG. 1 is a greatly simplified view of a switching device with an unactuated push button as switching organ;

FIG. 2 is a greatly simplified view of the switching device with the actuated push button as switching organ; and

FIG. 3 is a lateral view of a motor vehicle.

### DETAILED DESCRIPTION

The following detailed description is merely exemplary in nature and is not intended to limit application and uses. Furthermore, there is no intention to be bound by any theory presented in the preceding background or summary or the following detailed description.

A motor vehicle 2 with an internal combustion engine and/or electric motor as drive motor comprises a body and within the body an interior space is enclosed. In the interior space, a plurality of vehicle seats 23 is arranged and each of these comprise a seat part 25 and a back part 24. The back part 24 is pivotably mounted about a pivot axis 22 by means of a pivot mounting 21. The pivot axis 22 in this case is substantially oriented horizontally in transverse direction of the motor vehicle 2. The motor vehicle 2 is a three-door motor vehicle 2 with two side doors and one back door as opening door for the trunk. For this reason, a pivoting of the back parts 24 of the vehicle seats 23 as front seats is required in order to obtain suitable access to the back seats behind the front seats within the interior space.

For this reason, the pivotability of the back part 24 of the two vehicle seats 23 as front seats can be unlocked and locked by means of a locking mechanism 13 as mechanism 12. In a locked state of the locking mechanism 13, the back part 24 cannot be pivoted about the pivot axis 22, i.e. is fixedly unpivotable with respect to the pivot axis 22. In an unlocked state of the locking mechanism 13, the back part 24 can be pivoted about the pivot axis, so that because of this the occupants can more easily get in and out of the back seats through the two side doors and/or an individual adaptation of the pivot position of the back parts 24 for an occupant on this vehicle seat 23 is possible.

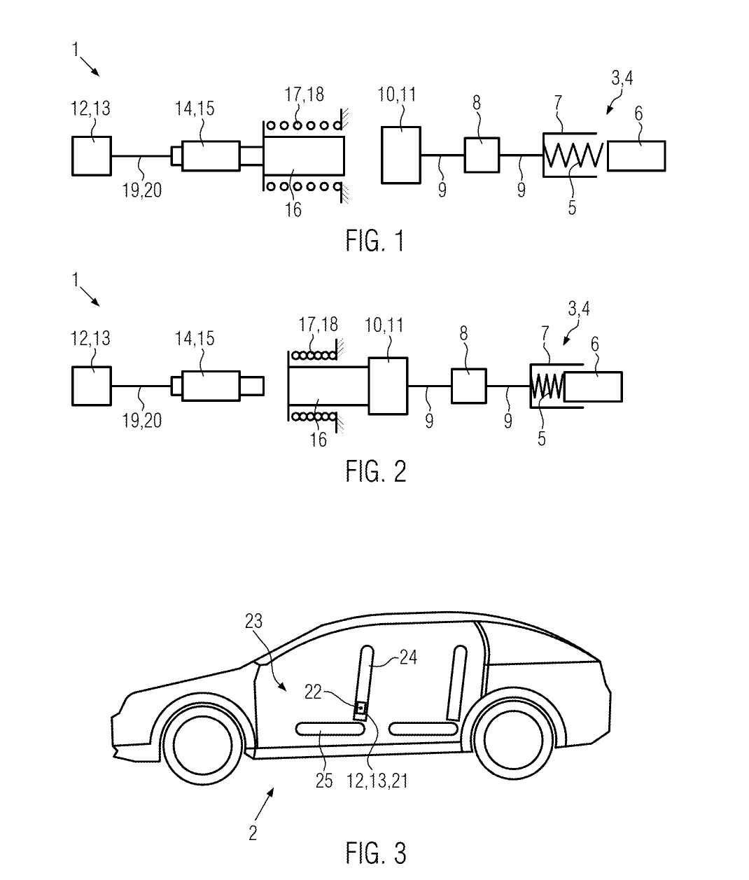

The motor vehicle 2 comprises a switching device 1 for changing the state of the locking mechanism 13, i.e., for changing the locking mechanism 13 from a locked state into an unlocked state and vice versa. The locked state of the locking mechanism in this case is considered as a first state and an unlocked state of the locking mechanism 13 in this case is considered as a second state of the locking mechanism 13 as mechanism 12. The switching device 1 comprises a push button 4 as switching organ (FIG. 1 and FIG. 2). The push button 4 in this case comprises a push button spring 5, a push button slide 6 and a push button housing 7. The push button spring 5 in this case exerts a pressure force on the bush button slide 6 and the push button slide 6 is moveably mounted on the push button housing 7 with the push button housing 7.

In FIG. 1, the push button 4 is in an unactuated state, i.e., no pressure force is exerted on the push button slide 6 and the push button slide 6 is predominantly pushed outside the push button housing 7 by the push button spring 5. By exerting a pressure force on the push button slide 6 to the outside by the occupant of the motor vehicle 2, for example with the finger, the push button slide 6 can be pushed further into the push button housing 7 against the pressure force exerted by the push button spring 5, so that push button slide 6 is in an actuated switching state further within the push button housing 7. By means of an electronic sensor that is not shown, the position of the push button slide 6 can be sensed and because of a control electronic system 8 the actuating of the push button 4 as switching organ 3 electronically sensed. For this purpose, the control electronic system 8 is connected to the switching organ 3 with current lines 9. The push button 4 is arranged within the interior space of the motor vehicle 2, for example on an instrument panel or in the region of the vehicle seat 23, for example on the seat part 25 or on an armrest between 2 front seats of the motor vehicle 2.

The control electronic system 8 is connected to an electromagnet 11 as actuator 10 through further current lines 9. The locking mechanism 13 is mechanically connected to a push-push mechanism 14 or a pull-pull mechanism 15 with a connecting part 19 as mechanical connecting part 19, i.e., a control cable 20. The push-push mechanism 14 or the pull-pull mechanism 15 in this case is actuated by a pin 16. On activating the actuator 10 as electromagnet 11, in that the electromagnet 11 is supplied with electric current for a period of time of approximately 100 ms, the pin 16 is removed from the push-push mechanism 14 or the pull-pull mechanism 15 against the pressure force exerted by an elastic element 17 as spring 18, so that because of this the pin 16 no longer lies on the push-push mechanism 14 or the pull-pull mechanism 15 but on the electromagnet 11.

FIG. 1 shows an unenergized or deactivated electromagnet 11, so that because of this the pin 16 lies on the push-push mechanism 14 or the pull-pull mechanism 15 and FIG. 2 shows an activated or energized electromagnet 11, so that because of this the pin 16 lies on the electromagnet 11. The locking mechanism 13 is operationally connected mechanically to the push-push mechanism 14 and the pull-pull mechanism 15 the control cable 20. If for example the locking mechanism 13 is in a first or locked state and the electromagnet is temporarily briefly energized for approximately 100 ms, the pin 16 is briefly attracted to the electromagnet 11 and following this after the end of the energizing, the pin 16 is again moved from the spring 18 to the push-push mechanism 14 or the pull-pull mechanism 15. The push-push mechanism 14 or the pull-pull mechanism 15 in this case corresponds to the mode of operation to a ball-point pin mechanism.

Through each actuating of the push-push mechanism or the pull-pull mechanism, i.e., the brief removing of the pin 16 and the subsequent placing of the pin 16 on the push-push mechanism 14 or pull-pull mechanism 15 again the control cable 20 is moved in such a way that because of this the state of the locking mechanism 13 is changed, i.e., for example from the first locked state to the second unlocked state. Following this, the state of the locking mechanism 13 is continuously and permanently retained even with the deactivated actuator 10. Only after a subsequent renewed brief energizing of the electromagnet 11 and the connected movement of the pin 16 described above, the state of the locking mechanism 13 is again changed by means of the push-push mechanism and the pull-pull mechanism 15 as well as by means of the control cable 20, for example from the second unlocked state to the first locked state. This can be repeated as often as desired.

The control electronic system 8 and thus the switching device 1 in this case is designed or switched because of the electronic components which are present to the effect that by actuating the switching organ 3, i.e., by pressing the push button 4 during a period of time of more than approximately 260 ms, the actuator 10 is briefly energized and because of this the locking mechanism 13 changed from the first locked state to the second unlocked state. If following the push button 4 remains continuously pressed over an extended period of time, the electromagnet 11 is not energized by the control electronic system 8. Only upon a releasing of the push button 4, i.e., with an unactuated switching organ 3 during a period of time of more than approximately 260 ms, is the electromagnet 11 temporarily energized again for a period of time of approximately 100 ms, so that because of this the state of the locking mechanism 13 is changed from the second unlocked state into the first locked state.

The predetermined period of time of approximately 260 ms for an actuated switching organ 3 or an unactuated switching organ 3, which energizing the electromagnet 11 requires, is necessary in order to avoid an unintentional energizing of the electromagnet 11 and a change of the locking state caused through this. If for example the push button 4 is pressed only very briefly, for example during a period of time between approximately 50 or approximately 200 ms, for example unintentionally or during an accident, this does not lead to a change of the state of the locking mechanism 13.

Seen as a whole, substantial advantages are connected to the switching device 1 according to the invention and the motor vehicle 2. For changing the state of the locking mechanism 13, the electromagnet 11 only has to be briefly supplied with electric current or approximately 100 ms. Because of this brief supply, electric energy is advantageously required only for changing the state of the locking mechanism 13, so that because of this very little energy is required. Only during a pressed push button 4 is the locking mechanism 13 unlocked, so that because of this the user of the motor vehicle 2 has a clear instruction for action, i.e., that the locking mechanism unlocks only during the permanent pressing of the push button 4 and because of this the back part 24 is pivotable about the pivot axis 22. In the case of an unactuated switching organ 3, i.e. with a push button 4 that is not pressed, the locking mechanism 13 is in the first or locked state.

While at least one exemplary embodiment has been presented in the foregoing summary and detailed description, it should be appreciated that a vast number of variations exist. It should also be appreciated that the exemplary embodiment or exemplary embodiments are only examples, and are not intended to limit the scope, applicability, or configuration in any way. Rather, the foregoing summary and detailed description will provide those skilled in the art with a convenient road map for implementing an exemplary embodiment, it being understood that various changes may be made in the function and arrangement of elements described in an exemplary embodiment without departing from the scope as set forth in the appended claims and their legal equivalents.

1. A switching device for a motor vehicle, comprising:
a switching organ;
an actuator that is configured to change a state;
a control electronic system that is configured to actuate the actuator as a function of actuating of the switching organ;
a mechanism operationally connected mechanically to the wherein the actuator so that upon a temporary activating of the actuator a first state of the mechanism is changeable from the first state into the second state and following the second state is continuously retained with the actuator up to a next temporary activating of the actuator and upon a temporary activating of the actuator the second state of the mechanism is changeable from the second state into the first state and following the first state is continuously retained with the actuator up to the next temporary activating of the actuator.

2. The switching device according to claim 1, wherein with each temporary activating of the actuator a state of the mechanism is changeable from the first state into a second state and following remains substantially continuously constant with the actuator up to the next temporary activating of the actuator.

3. The switching device according to claim 1, wherein the actuator is an electromagnet.

4. The switching device according to claim 1, wherein the actuator is activated for a period between approximately 10 s and approximately 1 ms supplied with current for changing the state of the mechanism.

5. The switching device according to claim 1, wherein the switching organ is a push button.

6. The switching device according to claim 5, Wherein the control electronic system is designed such that from a predetermined period between approximately 1 s and 10 ms of the switching organ the actuator is temporarily activated and the mechanism changed into the second state.

7. The switching device according to claim 1, wherein the control electronic system is designed such that from a predetermined period between approximately 1 s and 10 ms of the switching organ during which the mechanism is in the second state from the predetermined period of the switching organ of a relaxed push button, the actuator is temporarily activated and the mechanism is changed into the first state.

8. The switching device according to claim 1, wherein the mechanism is operationally connected mechanically with a connecting part operationally connected mechanically to the actuator and an elastic element acting on a pin.

9. The switching device according to claim 1, wherein the mechanism is a locking mechanism for a pivot mounting of a back part of a vehicle seat and the first state of the locking mechanism is a locked state and the second state of the locking mechanism is an unlocked state.

10. A motor vehicle, comprising:
a vehicle seat with a back part and a seat part;
a pivot mounting with a locking mechanism for the back part of the vehicle seat; and
a switching device that is configured to lock and unlock the locking mechanism,
wherein the switching device comprises: a switching organ;
an actuator that is configured to change a state;
a control electronic system that is configured to actuate the actuator as a function of actuating of the switching organ;
a mechanism operationally connected mechanically to the wherein the actuator so that upon a temporary activating of the actuator a first state of the mechanism is changeable from the first state into the second state and following the second state is continuously retained with the actuator up to a next temporary activating of the actuator and upon a temporary activating of the actuator the second state of the mechanism is changeable from the second state into the first state and following the first state is continuously retained with the actuator up to the next temporary activating of the actuator.

11. The switching device according to claim 1, wherein the mechanism is a pull-pull mechanism.

12. The switching device according to claim 1, wherein the mechanism is a push-push mechanism.

13. The switching device according to claim 1, wherein the actuator is activated for a period between approximately 1 s and approximately 10 ms supplied with current for changing the state of the mechanism.

14. The switching device according to claim 5, wherein the switching device are configured such that from a predetermined period preferentially between approximately 1 s and 10 ms of the switching organ and the actuator is temporarily activated and the mechanism changed into the second state.

15. The switching device according to claim 5, wherein the control electronic system is designed such that from a predetermined period between approximately 400 ms and 100 ms of the switching organ the actuator is temporarily activated and the mechanism changed into the second state.

16. The switching device according to claim 1, wherein the control electronic system is designed such that from a predetermined period between approximately 400 ms and 100 ms of the switching organ during which the mechanism is in the second state from the predetermined period of the switching organ, the actuator is temporarily activated and the mechanism is changed into the first state.

17. The switching device according to claim 5, wherein the switching device are configured such that from a predetermined period of time preferentially between approximately between 400 ms and 100 ms of the actuated switching organ and the actuator is temporarily activated and the mechanism changed into the second state.
